(19) United States
(12) Patent Application Publication
(10) Pub. No.: US 2011/0039215 A1
(43) Pub. Date: Feb. 17, 2011

(54) LABEL AND METHOD FOR PREPARING THE SAME

(75) Inventors: Jae Soon Kim, Gyeonggi-do (KR); Hee Sung An, Gyeonggi-do (KR); Han Jun Kang, Gyeonggi-do (KR); Sung Ho Lee, Gyeonggi-do (KR); Seok Hoon Lee, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: YOUL CHON CHEMICAL CO., LTD., Seoul (KR)

(21) Appl. No.: 12/299,948

(22) PCT Filed: Jul. 26, 2007
(86) PCT No.: PCT/KR2007/003609

§ 371 Date: Dec. 18, 2009

(30) Foreign Application Priority Data
Jul. 26, 2006 (KR) 10-2006-0070112

(51) Int. Cl. G03C 1/00; B41M 5/32

(52) U.S. Cl. 430/495.1; 427/150

(57) ABSTRACT

Disclosed is a label having an ink layer which has a metal or a metal oxide as its pigment, the color of the metal or the metal oxide being changed with an oxidation reaction of the metal or the metal oxide by laser irradiation, the laser irradiation causing the oxidation reaction of the metal oxide so as to make the metal oxide change in its oxidation number or come to a complete oxidation state from an incomplete oxidation state.

### TECHNICAL FIELD

The present invention relates to a label and a method for manufacturing the same, and particularly to a label and a method for manufacturing the same, wherein information on products such as vehicle, electronic, semiconductor, medical instrument and the like is recorded in the label, and then the label is attached to the products after its releasing film is removed, thereby enabling protection of forgery of the products and tracking of the products upon recalling the products.

### BACKGROUND ART

Products, for instance, vehicle has their own identification number, which is recorded on front and rear license metal plates of the vehicle. However, the metal plates are easy to attach and detach so that when a vehicle is stolen, it is very difficult to find and track the vehicle.

Thus, in order to prepare for vehicle thefts or recalls, it is necessary to attach a plate or a sticker, which records information on manufacturing country, manufacturing company, manufacturing factory location, license number, manufacturing year, respective constitutional components, and other characteristics, to an inside of the vehicle bumper or on a windshield of the vehicle.

The plate or the sticker is so called as a vehicle number label. In this regard, Korean Utility Model Registration No. 124645 disclose a metal plate as the vehicle number label. However, since the label is a metal plate, there are problems that rust is likely to occur only with a small scratch and as well forgery is easy.

Meanwhile, U.S. Pat. No. 6,066,437 disclose a label in which a metallic layer, for example, an aluminum layer, is removed by laser.

FIG. 1 is a schematic view illustrating a structure of the label including the metallic layer that is removed by laser.

In FIG. 1, the label includes a protection film 1, a metallic layer 3 which is positioned below the protection film 1 and removable by laser, a contrast layer 4 which is positioned below the metallic layer 3, an agglutinant layer 5 below the contrast layer 4 and a releasing film 6 below the agglutinant layer 5.

The label has an advantage of easily expressing texts or numbers by laser irradiation. However, according to the inventors, it has problems that as the metallic layer 3 is oxidized as time goes by, the quality of the label is gradually deteriorated.

Further, since powerful laser should be used for removal of the metallic layer 3 itself, there are also problems that the film is likely to break and workability can be reduced.

In addition, there is a problem that residue remains or the label are destroyed due to an excessive initial agglutinant force of the agglutinant layer 5 when worker mistakenly detaches the label and attaches the label again.

Therefore, according to the inventors, it is necessary to provide a label which records information on products such as vehicle, electronic, semiconductor and medical instrument so as to enable protection of forgery of the product and tracking of the product upon recall of the product, and wherein quality of the label is not gradually deteriorated as time goes by, workability in manufacturing the label is good, and initial agglutinant force is low while permanent adhesive force is high.

### DISCLOSURE

### Technical Problem

An object of the present invention is to provide a label and a method for manufacturing the same wherein printing property is good, quality of the label is not gradually deteriorated as time goes by, workability in manufacturing the label is high and manufacturing cost is low, the label is free from several pollutants in using the label, the label has chemical resistance and heat resistance, and initial agglutinant force of the label is low while permanent adhesion force of the label is high.

### Technical Solution

The present invention provides a label comprising an ink layer which comprises a metal or a metal oxide, the color of the metal or the metal oxide being changed with an oxidation reaction of the metal or the metal oxide by laser irradiation, the laser irradiation causing the oxidation reaction of the metal oxide so as to make the metal oxide change in its oxidation number or come to a complete oxidation state from an incomplete oxidation state.

In an embodiment of the present invention, the label comprises: a substrate film, the ink layer below the substrate film; an adhesive layer below the ink layer; an intermediate film below the adhesive layer; an agglutinant layer below the intermediate film; and a releasing film below the agglutinant layer.

In an embodiment of the present invention, the substrate film is treated with a surface protection in order to maximize marking efficiency and minimize damages of the film by YAG layer.

In an embodiment of the present invention, the substrate film is treated to have a gloss-free property.

In an embodiment of the present invention, the substrate film is a polyolefin resin film, and the polyolefin resin film is coated with opaque ink comprising urethane acrylate based resin in a thin thickness of more than 0 μm and 5 μm or less using a gravure coating method.

In an embodiment of the present invention, the substrate film has a thickness of 12 μm to 150 μm.

In an embodiment of the present invention, the substrate film is a polyolefin resin film, polyimide resin film or PET film.

In an embodiment of the present invention, the ink layer is a single layer.

In an embodiment of the present invention, a metal of the metal oxide is one selected from a group consisting of Ti, Cu, Fe, Al, Ni, Mg, Ag and Sb, in case that the ink layer is a single layer.

In an embodiment of the present invention, the ink layer is a multi-layer.

In an embodiment of the present invention, the ink layer comprises an upper ink layer of one-degree ink and a lower ink layer of two-degree ink, the lower ink layer of two-degree ink comprising the metal oxide, a metal of the metal oxide being one selected from a group consisting of Cu, Fe, Al, Ni, and Ag.

In an embodiment of the present invention, the ink layer comprises acrylate urethane based resin.

In an embodiment of the present invention, the ink layer contains 25 to 50 wt % of pigment over the whole ink.

In an embodiment of the present invention, the grain size of the pigment has a range of more than 0 μm and 1 μm or less.

In an embodiment of the present invention, the adhesive layer is an acrylic adhesive.

In an embodiment of the present invention, the intermediate film is a color-contrast layer wherein a portion of the color-contrast layer which corresponds to a laser-marked portion of the ink layer is transparent or has the same color as the laser-marked portion of the ink layer, a the portion of the color-contrast layer which corresponds to a non layer-marked portion of the ink layer has a color in contrast with that of the non layer-marked portion of the ink layer.

In an embodiment of the present invention, the intermediate film is a polyolefin resin film.

In an embodiment of the present invention, the intermediate film is a PET film.

In an embodiment of the present invention, the intermediate film has a thickness of 20 μm to 100 μm.

In an embodiment of the present invention, one or two of the substrate film and the intermediate film is half-cut.

In an embodiment of the present invention, the half-cutting is implemented up to 50%˜75% of a level of the color-contrast layer.

In an embodiment of the present invention, the agglutinant layer is formed with an acrylic agglutinant agent.

In an embodiment of the present invention, the adhesive layer has a peeling strength lower than that of the agglutinant layer in order to protect forgery of the label.

In an embodiment of the present invention, the releasing film is a PET releasing film coated with silicone.

There is provided a method for manufacturing a label comprising a step of providing an ink layer comprising a metal or a metal oxide, the color of the metal or the metal oxide being changed with an oxidation reaction of the metal or the metal oxide by laser irradiation, the laser irradiation causing the oxidation reaction of the metal oxide so as to make the metal oxide change in its oxidation number or come to a complete oxidation state from an incomplete oxidation state (S2).

In an embodiment of the present invention, the method comprises the steps of: providing a substrate film (S1); providing the ink layer below the substrate film (S2); providing an adhesive layer below the ink layer (S3); providing an intermediate film below the adhesive layer (S4); providing a agglutinant layer below the intermediate film (S5); and providing a releasing film below the agglutinant layer (S6).

In an embodiment of the present invention, the method further comprises implementing a heat treatment to the agglutinant layer so as to improve a permanent adhesion force after the label is attached to a target object.

### ADVANTAGEOUS EFFECTS

According to the label of the embodiments of the present invention, the printing property is good, quality of the label is not gradually deteriorated as time goes by, workability in manufacturing the label is high and manufacturing cost is low. Further, the label is free from several pollutants in using the label and has chemical resistance and heat resistance. In addition, initial agglutinant force of the label is low while permanent adhesion force of the label is high.

### DESCRIPTION OF DRAWINGS

FIG. 1 is a schematic view illustrating a structure of a conventional label comprising a metallic layer removed by laser beam;

FIG. 2 is a schematic view illustrating a structure of a label according to a first embodiment of the present invention with irradiation of laser;

FIG. 3 is a schematic view illustrating a structure of a label according to a second embodiment of the present invention with irradiation of laser;

FIG. 4 is a schematic view illustrating a structure of a label according to a third embodiment of the present invention with irradiation of laser;

FIG. 5 is a schematic view illustrating a structure of a label according to a fourth embodiment of the present invention with irradiation of laser; and

FIG. 6 is a schematic view illustrating the state where the label according to the third embodiment of the present invention is attached to a target object.

### MODE FOR INVENTION

Hereinafter, detailed description will be made with reference to the embodiments of the invention.

In an embodiment of the present invention, an ink layer is formed on a label for protection of forgery of products such as vehicles, etc., wherein the ink layer comprises a metal or a metal oxide as a pigment, and the metal or the metal oxide is changed in its color by an oxidation reaction of the metal or the metal oxide by laser irradiation, preferably YAG laser irradiation.

The label according to an embodiment of present invention includes a first label part, and preferably includes the first label part and a second label part formed below the first label part. Herein, in case that the second label part is processed with a half-cutting, it is possible to improve protection of forgery of the label. For reference, a substrate film of the second label part is referred to “intermediate film.”

FIG. 2 is a schematic view illustrating a structure of a label according to a first embodiment of the present invention with irradiation of laser.

As illustrated in FIG. 2, the label L according to the first embodiment of the present invention comprises a substrate film 11 and an ink layer 12 below the substrate film 11. The ink layer 12 comprises pigment and resin, and the pigment is a metal or a metal oxide.

An adhesive layer 13 is formed below the ink layer 12, and an intermediate film 14 which preferably serves as a color-contrast layer is formed below the adhesive layer 13. Specifically, the intermediate film 14 can be the color-contrast layer wherein a portion of the color-contrast layer which corresponds to a laser marked portion of the ink layer is transparent or has the same color as the laser-marked portion of the ink layer, and a portion of the color-contrast layer which corresponds to a non layer-marked portion of the ink layer has a color in contrast with that of the non layer-marked portion of the ink layer.

A agglutinant layer 15 is formed below the intermediate film 14, and a releasing film 16 is formed below the agglutinant layer 15.

The label L is irradiated with laser by a laser output device 20 (21a), and the irradiated laser passes through the substrate film 11 (21c) and reaches the ink layer 12 (21d). Such a laser generates heat with the conversion of light energy to heat energy through the collection of light, so that a metal in the ink layer 12 is oxidized to be a metal oxide, or if the ink layer has a metal oxide per se, the metal oxide is oxidized to be a metal oxide with different oxidation number or to be in a complete oxidation state from in an incomplete oxidation state, thereby causing color-change. For the laser, low power YAG layer is proper and the wavelength thereof is 1.064 nm, for example.

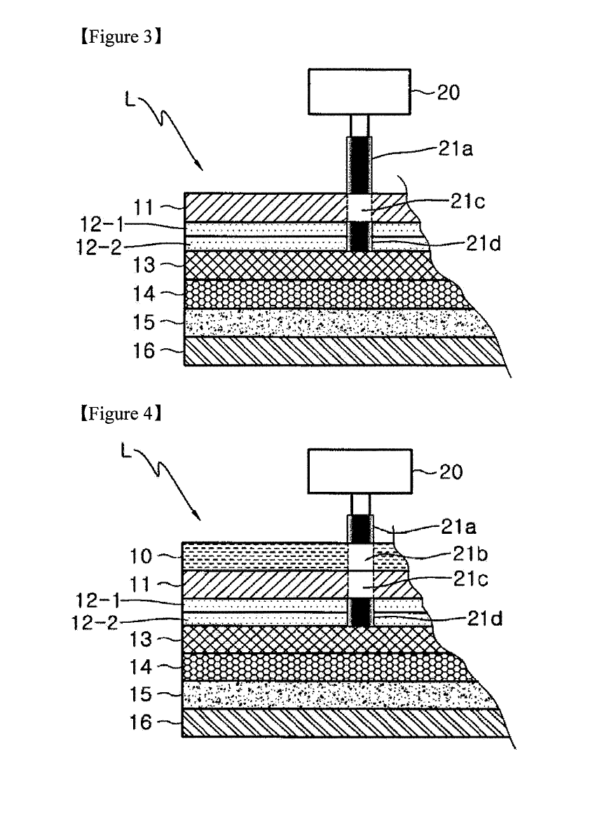

FIG. 3 is a schematic view illustrating a structure of a label according to a second embodiment of the present invention with irradiation of laser.

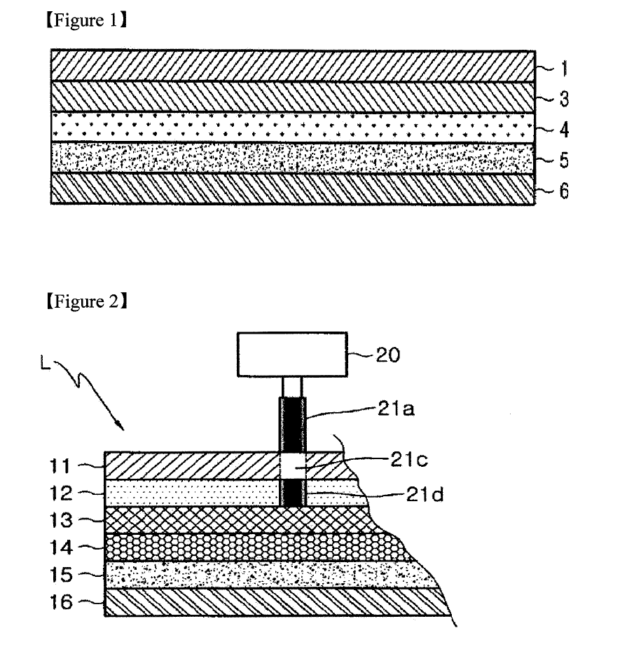

As illustrated in FIG. 3, the label L according to the second embodiment of the invention is similar to that of FIG. 1 except that the ink layer 12 is formed with a multi-layered structure. That is, the ink layer 12 of the label L of FIG. 3 consists of a primarily formed one-degree ink layer 12-1 and a secondarily formed two-degree ink layer 12-2.

FIG. 4 is a schematic view illustrating a structure of a label according to a third embodiment of the present invention with irradiation of laser.

As illustrated in FIG. 4, the label L according to the third embodiment of the invention is similar to that of FIG. 3 except that the substrate film 11 is surface-treated to have a surface protection layer 10 thereon, and the laser is irradiated trough the surface protection layer 10 (21b).

FIG. 5 is a schematic view illustrating a structure of a label according to a fourth embodiment of the present invention with irradiation of laser.

As illustrated in FIG. 5, the label L according to the fourth embodiment of the invention is similar to that of FIG. 4 except that a half-cutting is implemented several times in regular intervals to the intermediate film 14. To this end, the intermediate film 14 is likely to be peeled off, thereby improving the protection of forgery of the label.

Hereinafter, a method for manufacturing the label L according to an embodiment of the present invention will be explained.

First, a substrate film 11 is provided (S11). The substrate film 11 may be formed with, for example, a polyolefin or polyimide film. In an embodiment of the present invention, a heat resistance film is required because heat is generated by laser irradiation. Thus, a PET film having heat resistance, dimensional stability, and processing property is preferably used for the substrate film 11.

A thickness of the substrate film 11 can be adjusted according to the strength of the laser. The thickness is preferably set to 12 μm to 150 μm due to heat generated during irradiation of YAG laser with a wavelength of 1,064 nm, for example. If the thickness of the film 11 is less than 12 μm, upon laser processing, a layer separation phenomenon may occur, and if the thickness exceeds 150 μm, an oxidation reaction can not occur sufficiently in the lower ink layer 12 at the laser strength, causing a problem that characters or numbers can not appear definitely.

Meanwhile, as described before, the substrate film 11 is surface-treated to further provide the surface protection layer 10 thereon. Herein, the surface protection layer 10 is formed by implementing a gloss-free treatment, i.e., a matte treatment, on the laser-irradiated surface so as to prevent light scattering and to this end maximize the marking efficiency and minimize the damage of the label surface due to the light scattering upon the laser irradiation.

The matte-treated surface protection layer 10 is formed by the following specific method, for example.

That is, the polyolefin resin film which is the substrate film 11 is coated with compound of pigments providing opaque color, such as silica (SiO₂), calcium carbonate (CaCO₃), or barium sulfate (BaSO₄) based pigments, and urethane acrylic resin by using a gravure printing method, thereby forming the matte-treated surface protection layer.

For another manufacturing method of the matte-treated surface protection layer, PP resin and HDPE resin can be used. When a film is made of the PP resin and HDPE resin, the film comes to be opaque and matte due to a refraction index of the mixed resin wherein the PP resin and the HDPE resin are not blended with each other. The film is then disposed on the substrate film by a lamination process.

In case of vehicle number label, the label should secure heat resistance (about 150° C.) to some extent to prevent thermal deformation by laser irradiation. To this end, a PET film having heat resistance is preferably used for the surface protection layer. Meanwhile, when the polyolefin film is coated thicky with the compound, the ink layer is likely not to show its own color, so that it is preferable to implement a very thin coating (more than 0 μm and 5 μm or less) by a gravure coating method and the like.

Next, the ink layer 12 is formed below the substrate film 11 (S2).

Herein, a gravure printing or a micro gravure printing capable of conducting mass production and reducing manufacturing cost can be used preferably. To improve printing homogeneity and efficiency of laser marking in the gravure printing or the micro gravure printing, a printing cylinder can be preferably manufactured using laser. Further, to maximize the laser marking quality, the ink layer 12 is preferably implemented with a very thin coating exceeding 0 μm and 5 μm or less. If exceeding 5 μm, it is possible to form non-oxidized ink layer after laser irradiation. In view of clear marking, the thickness of the ink layer 12 can be set to be 1 μm to 2 μm, more preferably.

Such an ink layer 12 is for expressing desired texts or numbers thereon through the oxidation reaction by the laser irradiation. The ink layer 12 uses resin and ink comprising the pigment including the metal oxidized by laser irradiation, preferably metal oxide oxidized by laser irradiation, which metal oxide changes in its oxidation number or comes to a complete oxidation state from an incomplete oxidation state, so that the ink layer can be formed with a single-layered structure. The ink layer 12 can also be intentionally formed to have a multi-layered structure like one-degree and two-degree ink layers 12-1 and 12-2 as illustrated in FIG. 3.

Specifically, the ink in the ink layer 12 is composed of a pigment and resin. For the resin, acrylate urethane based resin can be preferably used.

The pigment can include a metal to be oxidized by laser, preferably, a metal oxide to be oxidized by laser so as to change in its oxidation number or to come to a complete oxidation state from an incomplete oxidation state. A metal of the metal oxide may be preferably one selected from, for example, Ti, Fe, Ag, Cu, Ni, Al, Mg and Sb. Meanwhile, in order to easily cause an oxidation reaction by laser irradiation, it is preferable to use a metal oxide to be oxidized so as to change in its metal oxidation number or to come to a complete oxidation state from an incomplete oxidation state. For example, TiO is to be oxidized by a laser to produce white TiO₂, which expresses the white color. Further, Fe₂O₂, Cu₂O, Ag₂O, Al₂O₂, Mg₂O or the like also are the metal oxides which are color-changeable through their oxidation reaction by laser. Texts or numbers recorded on the label show different colors according to the metal used. For example, it is possible to express red color by finally forming a ferric oxide through oxidation reaction by laser irradiation.

Meanwhile, in case where the ink layer 12 is formed with multi-layered structure as described above, the pigment having the metal oxide of the one metal selected from Cu, Fe, Al, Ni and Ag, which are excellent in laser absorption, is applied to the two-degree ink layer 12-2. When the metal oxide having the high laser absorption is applied to the two-degree ink layer 12-2, concealment and marking efficiency can be increased, and diverse colors can be easily shown.

In an embodiment of the present invention, the content of the pigment of the ink layer 12 can be preferably 25 wt % to 50 wt % over the whole ink. If the pigment is added less than 25 wt %, the clearness of the color can be deteriorated, and if exceeding 50 wt %, the marking efficiency can be reduced upon laser irradiation. In view of the foregoing, it can be more preferable that the content of the pigment is 30 wt % to 35 wt %.

For homogeneity of the laser marking quality, it also needs to adjust a grain size of the pigment particles. It can be preferable that the grain size of the pigment particles has a range of more than 0 μm and 1 μm or less. If more than 1 μm, good marking efficiency cannot be obtained. That is, as the grain size is smaller within the range, the pigments come to be more densely in the ink layer 12, so that all the laser-irradiated portion can be oxidized to show clear color and provide excellent marking result. However, if the grain size exceeds 1 μm, said good marking effect cannot be obtained.

With the formation of the ink layer 12, the laser marking state can be made very excellent unlike the existing laser marking film, and with the formation of single-layered structure, the manufacturing cost can be saved, the gradual deterioration in quality can be reduced, and the convenience in processing can be secured. Furthermore, when the pigment including the metal or the metal oxide, which is changeable in color through its oxidation reaction by the laser irradiation is applied to the ink layer, the concealment can be improved so that it is possible to prevent a phenomenon wherein the whole color other than the texts or numbers becomes dim since the intermediate film 14 below the ink layer 12 is visible.

Next, the adhesive layer 13 is formed below the ink layer 12 (S3).

If the adhesion force is maintained when the laser is irradiated, the adhesive should have printability and adhesion stability (thermal stability), chemical resistance, and oil resistance. In an embodiment of the present invention, an acrylate adhesive having excellent heat resistance is used to restrict the occurrence of layer separation phenomenon upon the laser irradiation.

Meanwhile, as the acrylate adhesive, low or high viscosity adhesive can be used. In case of low viscosity acrylate adhesive, the gravure coating method can be used, and in case of high viscosity acrylate adhesive, “S” knife method (so called, comma coating) can be used. Herein, the acrylate adhesive can be applied in 10 to 15 g/m² in wetting condition.

Next, the intermediate film 14 is formed below the adhesive layer 13 (S4). For the intermediate film 14, for example, a polyolefin resin film, or preferably a PET film can be used.

In case of using the polyolefin resin film, it is possible to express the color of the ink layer 12 shown by the laser irradiation more clearly. For example, in case where the ink layer 12 is expressed in white color through an oxidation reaction after the laser irradiation, the intermediate film 14 in milk white color can be used. Since the intermediate film 14 should be prevented from being perforated, it is preferable to use a PET film having a thickness of 20˜100 μm. If the thickness is less than 20 μm, the stiffness of the label is weakened, and upon attaching the label to a target object, bubbles are generated between the surface of the target object and the label, which deteriorate the adhesion performance. If the thickness exceeds the 100 μm, the laser output required for label cutting from the substrate film 11 to the agglutinant layer 15 should be increased, so that the lifetime of the laser apparatus can be short and the manufacturing cost can be also increased.

Meanwhile, as described before, it can be preferable to further implement a half-cutting to the intermediate film 14 for protection of forgery of the label. That is, through the half-cutting, if one tries to detach a label L attached to a target object for forgery, the intermediate film 14 weakened by the half-cutting is induced to be broken and thus peeled off, thereby improving the protection of forgery of the label. Such a half-cutting can be preferably implemented to 50% to 75% of the level of the intermediate film 14. Meanwhile, although the half-cutting is implemented vertically as shown in FIG. 5, it is also possible to implement the half-cutting at a certain angle.

Next, the agglutinant layer 15 is formed below the intermediate film 14 (S5). To this end, an acrylate adhesive is applied onto the intermediate film 14 in a “S” knife manner thus to form the agglutinant layer 15.

In am embodiment of the present invention, the adhesive layer 13 is formed below the ink layer 12 and the agglutinant layer 15 is formed below the intermediate film 14. Since it is possible to make both layers each have different peeling-off strengths, it is possible to provide the protection of forgery of the label.

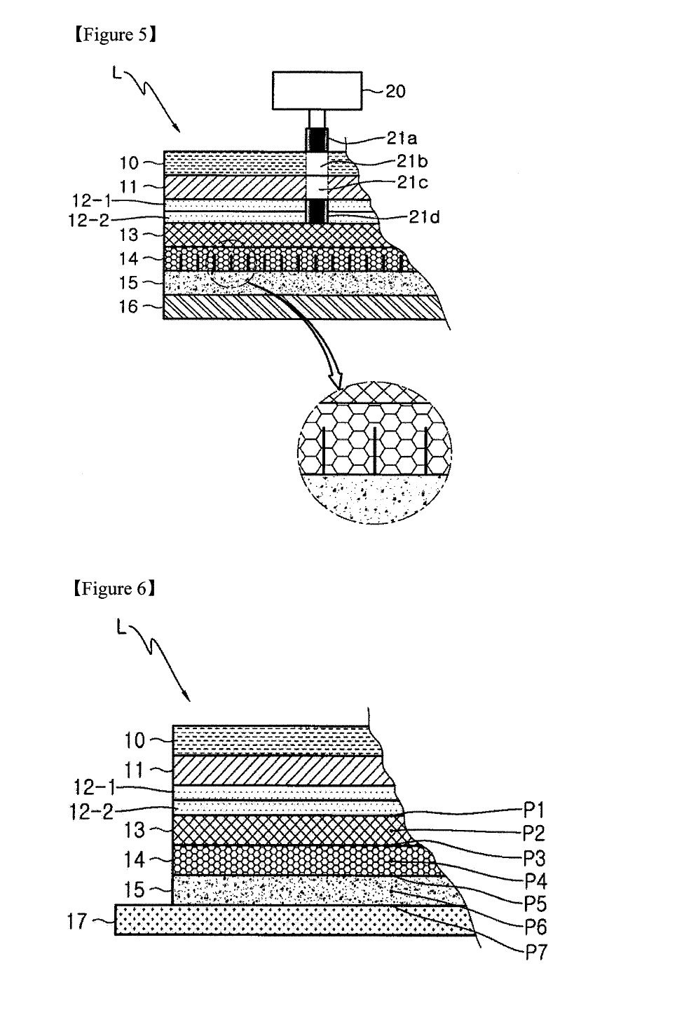

FIG. 6 is a schematic view illustrating the state where the label according to the third embodiment of the present invention is attached to a target object.

As illustrated in FIG. 6, for example, the peeling-off position in case where the label L according to the third embodiment of the invention is attached to the target object after the releasing film 16 is removed can be any position of P1, P2, and P3 adjacent to the adhesive layer 13 among the predicted peeling-off positions indicated as P1˜P7 because of the difference between the peeling-off strengths of the adhesive layer 13 and the agglutinant layer 15.

More specifically, in order to check the difference between the peeling-off strengths, tests were carried out for checking interlayer peeling-off strengths (examples 1 and 2) when the single or multiple layers of the ink layer and the intermediate film 14 are bonded to each other using an adhesive (acrylic adhesive), and initial and permanent agglutinatn forces (examples 3 and 4) when the label L is attached to mirror SUS (using an acrylic agglutinant agent).

In examples 1 and 2, the test speed was set to 200 mm/min, an interval between the upper and lower clips is set to 30 mm, and the measurement was performed five times and an average value was calculated.

In example 3, mirror SUS was used, the peeling-off was done at 90 degrees, and the measurement of the peeling-off strength was carried out at 300 mm/min. Then, the measurement was done after 30 minutes after passing through 2 kgf roller two times after the SUS, and an average value was calculated through five times measurements.

In example 4, mirror SUS was used, the peeling-off was done at 90 degrees, and the measurement of the peeling-off strength was carried out at 300 mm/min. Then, the measurement was done after aging at 80° C. for 7 days after 30 minutes after passing through 2 kgf roller two times after the SUS, and an average value was calculated through five times measurements.

Table 1 shows the measurement results.

TABLE 1

| | | Peeling-off |
|---|---|---|
| | | Strength(Kgf/25 mm) |
| Adhesion Force Test | Example 1 | 0.35 |
| | Example 2 | 0.33 |
| Agglutinant Force Test | Example 3 | 2.07 |
| | Example 4 | 3.14 |

As can be seen from the result, the peeling-off strength of the adhesive is about 0.33 to 0.35, and the difference from the agglutinant force is shown as 5 to 9 times. This means that when one tries to peel off the label L for forgery, the peeling-off occurs at the position P1, P2, or P3 of the adhesive layer 14 between the ink layer 12 and the intermediate film 14, rather than the position P5, P6 or P7 of the agglutinant layer 15 attached to the target object 17, so that the protection of forgery of the label can be provided.

However, if the half-cutting is implemented to the intermediate film 14 as described before, the peeling-off will occur at P4.

Meanwhile, in an embodiment of the present invention, in order to easily detach the label, which is attached to a wrong position by mistake, the agglutinant layer 15 is formed so that an initial agglitinant force is made relatively low (relatively lower than that of the case of applying heat as described below), and after attachment to the target object, heat above a certain temperature (80˜90° C.) is applied to increase the permanent adhesion force. For example, in a vehicle number label, its permanent adhesion force can be increased after attached to the target object because heat is applied naturally during its use. Thus, in case of trying to intentionally detach the label, the film starts to break from the ink layer.

Next, the release film 16 is formed below the agglutinant layer 15 (S6).

As the release film 16, a PET release film applied with silicone serving to regulate the release force can be used. Herein, together with the silicone, an epoxy based silane crosslink agent and a Pt catalyst can be used as an curing agent and an additive, respectively.

### INDUSTRIAL APPLICABILITY

As set forth before, the label according to embodiments of the present invention can be adapted to various products such as vehicle, electronic, semiconductor, or medical instrument, which need tracking in connection with protection of forgery, reliability control or quality control of the products.

1. A label comprising an ink layer which comprises a metal or a metal oxide,
the color of the metal or the metal oxide being changed with an oxidation reaction of the metal or the metal oxide by laser irradiation,
the laser irradiation causing the oxidation reaction of the metal oxide so as to make the metal oxide change in its oxidation number or come to a complete oxidation state from an incomplete oxidation state.

2. The label according to claim 1, wherein the label comprises a substrate film; the ink layer below the substrate film; an adhesive layer below the ink layer; an intermediate film below the adhesive layer; and an agglutinant layer below the intermediate film.

3. The label according to claim 2, wherein the substrate film is treated to have a gloss-free property.

4. The label according to claim 2, wherein the substrate film is a polyolefin resin film, and the polyolefin resin film is coated with opaque ink comprising urethane acrylate based resin in a thin thickness of more than 0 μm and 5 μm or less using a gravure coating method.

5. The label according to claim 2, wherein the substrate film has a thickness of 12˜150 μm.

6. The label according to claim 1, wherein the ink layer is a single layer, and a metal of the metal oxide is one selected from a group consisting of Ti, Cu, Fe, Al, Ni, Mg, Ag and Sb.

7. The label according to claim 1, wherein the ink layer is a multi-layer, and the ink layer comprises an upper ink layer of one-degree ink and a lower ink layer of two-degree ink, the lower ink layer of two-degree ink comprises the metal oxide, and a metal of the metal oxide is one selected from a group consisting of Cu, Fe, Al, Ni and Ag.

8. The label according to claim 1, wherein the ink layer contains 25˜50 wt % pigment over the whole ink.

9. The label according to claim 1, wherein the grain size of the pigment has a range of more than 0 μm and 1 μm or less.

10. The label according to claim 2, wherein the intermediate film is a color-contrast layer wherein a portion of the color-contrast layer which corresponds to a laser-marked portion of the ink layer is transparent or has the same color as the laser-marked portion of the ink layer, a the portion of the color-contrast layer which corresponds to a non layer-marked portion of the ink layer has a color in contrast with that of the non layer-marked portion of the ink layer.

11. The label according to claim 2, wherein the intermediate film has a thickness of 20˜100 μm.

12. The label according to claim 2, wherein one or two of the substrate film and the intermediate film is half-cut.

13. The label according to claim 12, wherein the half-cutting is implemented to 50˜75% of a level of the color-contrast layer.

14. The label according to claim 2, wherein the adhesive layer has a peeling-off strength lower than that of the agglutinant layer.

15. The label according to claim 2, wherein the label further comprises a releasing film below the agglutinant layer.

16. A method for manufacturing a label comprising a step of:
providing an ink layer comprising a metal or a metal oxide, the color of the metal or the metal oxide being changed with an oxidation reaction of the metal or the metal oxide by laser irradiation, the laser irradiation causing the oxidation reaction of the metal oxide so as to make the metal oxide change in its oxidation number or come to a complete oxidation state from an incomplete oxidation state (S2).

17. The method according to claim 16, wherein the method comprises the steps of:
providing a substrate film (S1);
providing the ink layer below the substrate film (S2);
providing an adhesive layer below the ink layer (S3);
providing an intermediate film below the adhesive layer (S4); and
providing a agglutinant layer below the intermediate film (S5).

18. The method according to claim 16, wherein the method further comprises implementing a heat treatment to the agglutinant layer so as to improve a permanent adhesion force after the label is attached to a target object.

19. The method according to claim 16, wherein the method further comprises the step of providing a release film below the agglutinant layer (S6).
